(19) United States
(12) Patent Application Publication
(10) Pub. No.: US 2026/0329087 A1
(43) Pub. Date: Oct. 22, 2026

(54) OUTPUT COUPLING GRATINGS FOR WAVEGUIDE-BASED DISPLAYS

(71) Applicant: SONY GROUP CORPORATION, Tokyo (JP)

(72) Inventors: Sebastien DE CUNSEL, Atsugi (JP); Kazue SHIMIZU, Kanagawa (JP); Christophe PEROZ, Tokyo (JP)

(73) Assignee: SONY GROUP CORPORATION, Tokyo (JP)

(21) Appl. No.: 19/110,634

(22) PCT Filed: Sep. 14, 2023
(86) PCT No.: PCT/JP2023/033539

§ 371 Date: Mar. 11, 2025

Related U.S. Application Data
(60) Provisional application No. 63/408,983, filed on Sep. 22, 2022.

(51) Int. Cl. G02B 27/01; G02B 5/18; G02B 27/00

(52) U.S. Cl. CPC G02B 27/0172; G02B 5/1819; G02B 5/1842; G02B 27/0081; G02B 2027/0178

(57) ABSTRACT

An (OCG) for a waveguide-based display comprises a base substrate and a plurality of unit cells arranged in groups on the base substrate. Unit cells of a first group each include a first photonic structure in a first orientation and having a first size and a first shape, and unit cells of a second group each include a second photonic structure in a second orientation and having a second size and a second shape. One or more of the first orientation, the first size, and the first shape of the first photonic structure are different than the second orientation, the second size, and the second shape of the second photonic structure.

### TECHNICAL FIELD

Example embodiments relate to output coupling gratings (OCGs) for waveguide-based displays.

### BACKGROUND ART

Waveguide-based displays may be used for near-eye display devices such as head mounted display (HMD) devices in augmented reality (AR) and/or mixed reality (MR) applications. Coupling of light at the input and the output of a waveguide affects the quality of image as seen by a user of a HMD.

### SUMMARY

An illustrative embodiment is directed to an (OCG) for a waveguide-based display. The OCG comprises a base substrate and a plurality of unit cells arranged in groups on the base substrate. Unit cells of a first group each include a first photonic structure in a first orientation and having a first size and a first shape, and unit cells of a second group each include a second photonic structure in a second orientation and having a second size and a second shape. One or more of the first orientation, the first size, and the first shape of the first photonic structure are different than the second orientation, the second size, and the second shape of the second photonic structure.

In another illustrated embodiment, a waveguide comprises a base substrate, an input coupling grating (ICG) that receives light from a light source, and an output coupling grating (OCG) that outputs light. The OCG includes a plurality of unit cells arranged in groups on the base substrate at regular intervals. Unit cells in at least one group of unit cells each include a first photonic structure having an even number of sides greater than six when viewed from a plan view, and each side of the first photonic structure is parallel to at least two other sides of the first photonic structure.

In yet another illustrative embodiment, a system comprises a light source, and a waveguide comprising an input coupling grating (ICG) that receives light from the light source and an output coupling grating (OCG) that outputs light. The OCG comprises a base substrate, and a plurality of unit cells arranged in groups on the base substrate, wherein unit cells of a first group each include a first photonic structure in a first orientation and having a first size and a first shape, and wherein unit cells of a second group each include a second photonic structure in a second orientation and having a second size and a second shape, wherein one or more of the first orientation, the first size, and the first shape of the first photonic structure are different than the second orientation, the second size, and the second shape of the second photonic structure.

### BRIEF DESCRIPTION OF DRAWINGS

FIG. 1 is a block diagram of a system according to at least one example embodiment.

FIG. 2 illustrates a schematic view of a display device and an example of a k-space design diagram for the display device according to at least one example embodiment.

FIG. 3 illustrates a k-space design that defines a unit cell according to at least one example embodiment

FIG. 4 illustrates an example structure of an OCG including a plurality of unit cells according to at least one example embodiment.

FIG. 5 illustrates four example photonic structures according to at least one example embodiment.

FIG. 6 illustrates diffraction characteristics for two different photonic structures according to at least one example embodiment.

FIG. 7 illustrates diffraction characteristics for three different unit cells that each have multiple layers of photonic structures according to at least one example embodiment.

FIG. 8 illustrates another example design for a photonic structure within a unit cell according to at least one example embodiment.

FIG. 9 illustrates a schematic view of a head mounted display (HMD) according to at least one example embodiment.

### DESCRIPTION OF EMBODIMENTS

Photonic waveguides are promising optical building blocks for the development of Augmented Reality (AR)/Mixed Reality (MR) displays. Photonic waveguides employ multiple diffractive optical elements to replicate an image generated by optical engine (light source) and display the image to a user's eyes. Light from the optical engine propagates through the waveguide by Total Internal Reflection (TIR) and can be schematically divided into three main functionalities: input pupil coupling, pupil replication (or expansion), and output pupil coupling. The development of highly efficient AR/MR display requires the optimization of these three functionalities through the combination of photonic micro/nanostructures. The photonic structures are used to control the path of the TIR light inside the waveguide as well as outcoupling of the light towards the user eye with the best image quality possible. Some photonic structures include one-dimensional linear gratings which can be blazed, multi-stepped or slanted and the height and orientation of the gratings affect diffraction efficiency. Two-dimensional gratings have been proposed to control the TIR light propagation and achieved higher image quality, especially uniformity and output efficiency. These structures have limited tunability of the diffracted orders and limit the overall performance of the waveguide.

Embodiments of the present disclosure propose photonic structures for high tunability of the diffracted orders in order to achieve high optical image quality—especially high brightness and high uniformity—in, for example, an AR display. The photonic structures (also called photonic elements) are contained in a specific unit cell which are periodically repeated in two axes with defined pitches Λ_{PC1} and Λ_{PC2} to form a photonic crystal. Shapes of the photonic elements may be based on a reference shape, such as a parallelogram, and may be cropped according to specific rules. Photonic elements may be stacked to provide a multi-layer structure that enhances functionality. The shapes of photonic elements may vary across the output coupling region of the waveguide to increase image quality.

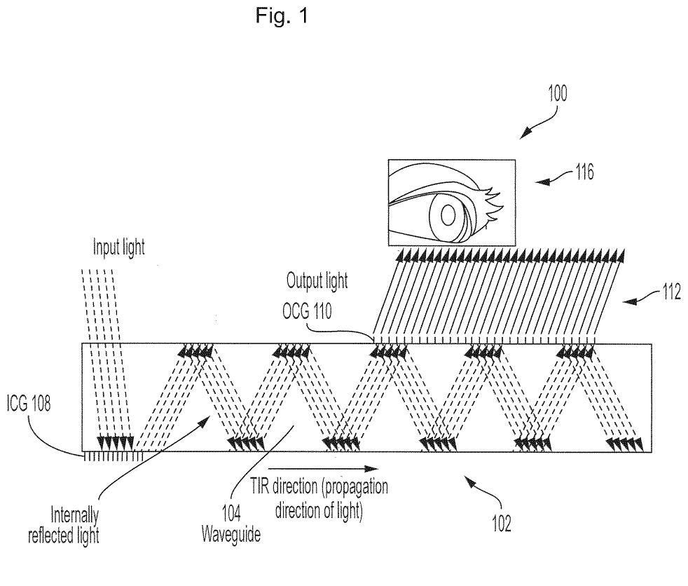

FIG. 1 is a block diagram of a system 100 including a display device 102 according to at least one example embodiment. The display device 102 may be a waveguide-based display and include a waveguide 104, an input coupling grating (ICG) 108, an output coupling grating (OCG) 110, and an eyebox 112 that outputs light to a user 116.

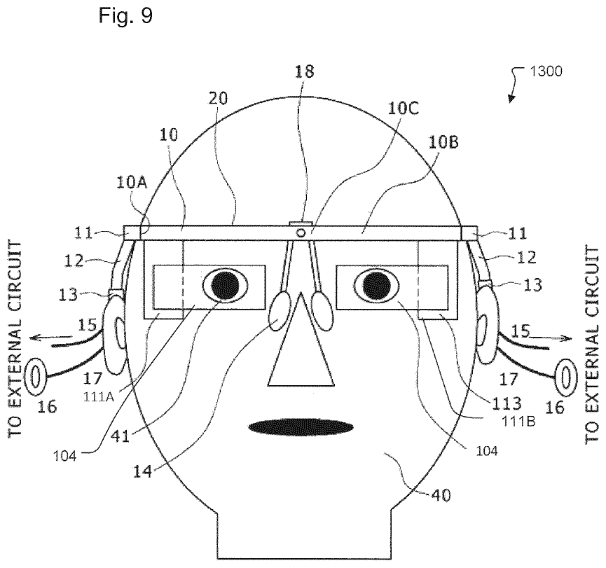

The waveguide 104 receives input light incident on a first surface of the waveguide 104 from a light source or an image generating device (not shown, but see FIG. 9 for additional detail of an image generating device). The received light is received by an input region of the ICG 108 on a first surface of the waveguide 104 and redirected (e.g., diffracted) at a propagation angle for internal reflection (e.g., total internal reflection (TIR)) within the waveguide 104). The internally reflected light may travel within the waveguide 104 before encountering the OCG 110 at a second surface of the waveguide 104. The waveguide 104 may be fixed to or on a substrate or base (not illustrated). The OCG 110 has a structure that diffracts at least some of the internally reflected light to an eyebox 112 of the display device 102 as output light for viewing by the user 116. An area of the waveguide 104 located between the ICG 108 and OCG 110 may correspond to an expansion area. The input light may be generated by the light source under control of image processing circuitry (not shown) or an image generating device that controls the light source to output light in a manner that displays a still image and/or moving images to the user 116 through the eyebox 112, thereby providing an AR image or MR image to the user 116. The eyebox 112 may include an area or volume in which a user's eye will receive a view of the output light. The light source may comprise any suitable light source used for diffractive waveguide applications, for example, one or more light emitting diodes (LEDs) or other light source coupled with one or more lenses and/or prisms that direct light to the waveguide 104.

The above mentioned image processing circuitry and image generating device may comprise a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the image processing circuitry may comprise hardware, such as an application specific integrated circuit (ASIC). Other non-limiting examples of the image processing circuitry include an Integrated Circuit (IC) chip, a Central Processing Unit (CPU), a Graphics Processing Unit (GPU), a microprocessor, a Field Programmable Gate Array (FPGA), a digital signal processor (DSP), a collection of logic gates or transistors, resistors, capacitors, inductors, diodes, or the like. Some or all of the image processing circuitry may be provided on a Printed Circuit Board (PCB) or collection of PCBs. It should be appreciated that any appropriate type of electrical component or collection of electrical components may be suitable for inclusion in the image processing circuitry.

The waveguide 104 may comprise any suitable material for diffractive waveguide applications, for example, glass, plastic, polymer, or other suitable organic or inorganic optical material. The waveguide 104 may be implemented in any suitable manner. For example, the waveguide 104 may comprise a core and one or more cladding layers, where the core and the cladding layer(s) have different dielectric constants. In another example, the waveguide 104 may be implemented with silicon photonics.

As described herein, the ICG 108 and/or OCG 110 may comprise photonic structures (e.g., protrusions and/or indentations) at one or more surfaces of the waveguide 104 (see discussion of photonic structures 500 and 800 below). As such, the ICG 108 and OCG 110 may be considered as Surface Relief Gratings (SRGs). FIG. 1 shows an example where both the ICG 108 and OCG 110 are on a single surface of the waveguide 104 in the figure (bottom surface for ICG 108 and top surface for OCG 110). However, the same or similar photonic structures may additionally or alternatively be on the opposite surface of the waveguide 104 (i.e., the top surface for ICG 108 and bottom surface for OCG 110). The photonic structures of each of the ICG 108 and OCG 110 may be formed according to suitable methods, such as nanoimprint lithography methods and/or ink-jet printing methods. The photonic structures of each of the ICG 108 and OCG 110 may be formed on the surface(s) of the waveguide 104 (i.e., the photonic structures are not part of the waveguide 104, but instead placed on the surface(s) of waveguide 104) and/or included as part of the surface(s) of the waveguide 104. The photonic structures of each of the ICG 108 and OCG 110 may take a suitable shape or form. For example, the photonic structures may comprise one-dimensional structures (e.g., linear structures), two-dimensional structure (pillars, holes, and/or the like), metasurfaces, and/or other suitable form. In any event, the specific design of the photonic structures of ICG 108 and/or OCG 110 may be based on the optical characteristics desired for the output light of the display device 102. As described in more detail below, the OCG 110 may include photonic structures arranged into unit cells designed to improve brightness and uniformity of an image output to the eyebox 112.

The eyebox 112 may correspond to a volume of free space where the eye of the user 116 receives a view of an image created by the light output from the OCG 110. The size and location of this volume may be based on optical architecture choices in which designers trade-off a number of constraints, such as field of view (FOV), image quality, and product design.

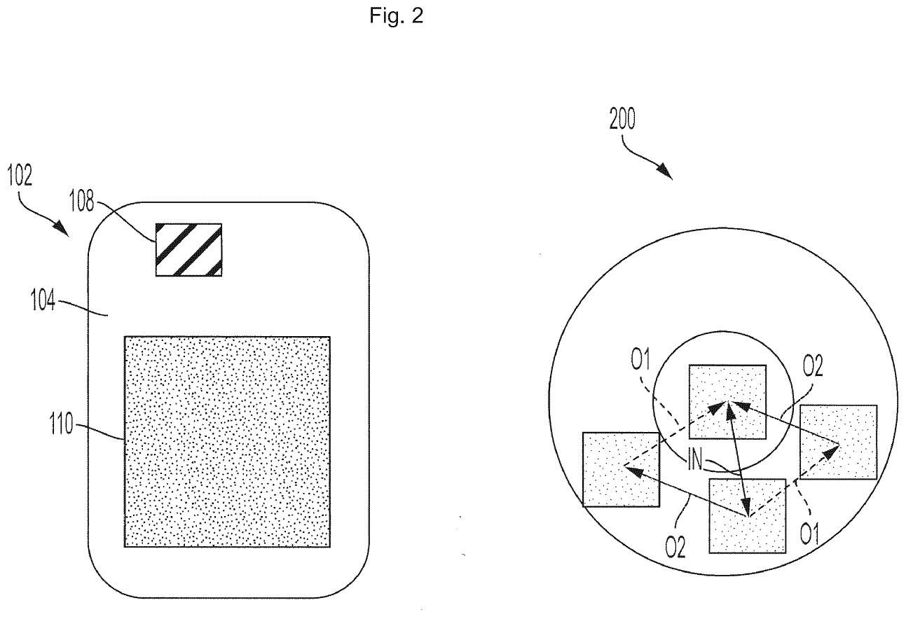

FIG. 2 illustrates a schematic view of a display device 102 and an example of a k-space design diagram for the display device 102 according to at least one example embodiment. As may be appreciated from the k-space design diagram 200, IN is the in-coupling vector for ICG 108, while O1 and O2 are the expansion and outcoupling unit vectors, respectively, for the expansion area of the waveguide and the OCG 110. As described herein, photonic structures of an OCG 110 may be divided into unit cells arranged at a substantially same pitch. The term “substantially” is used to account for variations in a value, such as pitch, that may occur as a result of the manufacturing process. Stated another way, the photonic structures are arranged at a substantially same pitch in that the pitch is within manufacturing tolerances. In some cases, the pitch is within some other acceptable deviation from a standard pitch value (e.g., within +/−5% of a standard pitch value).

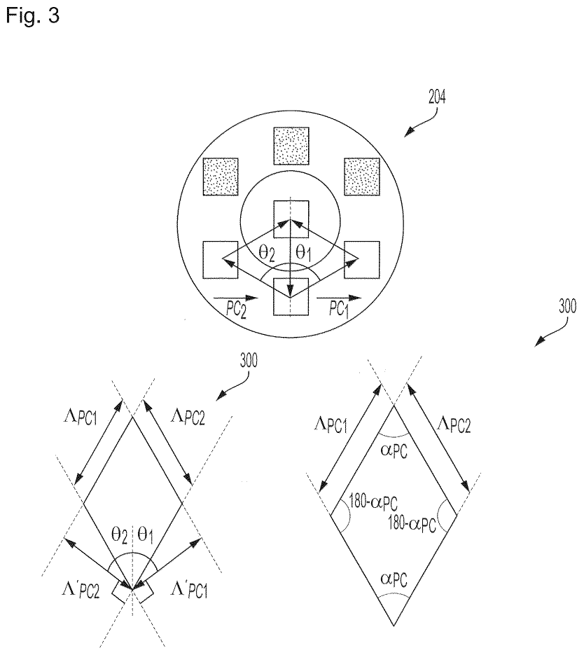

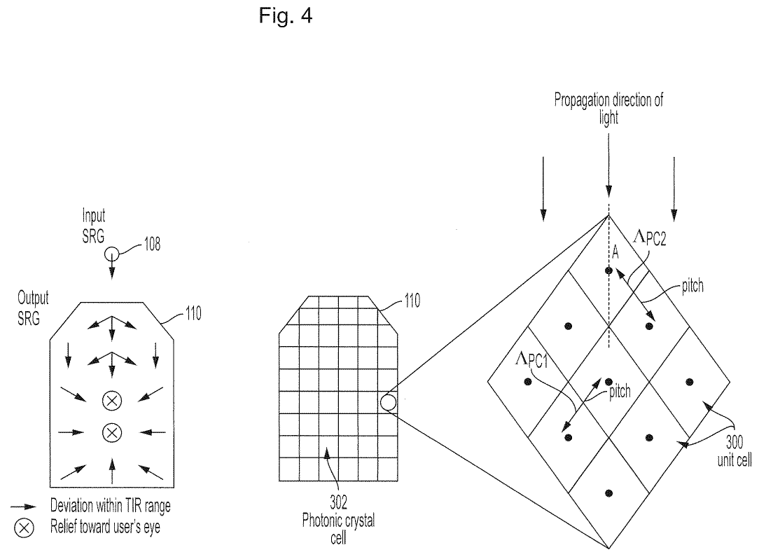

FIGS. 3 and 4 illustrates various details of an OCG 110 according to at least one example embodiment. More specifically, FIG. 3 illustrates a k-space design 204 that defines a unit cell 300 while FIG. 4 illustrates an example structure of an OCG 110 including a plurality of unit cells 300. As shown in FIG. 3, Λ′_{PC1} and Λ′_{PC2} are defined with grating vector:

Λ_{PC1}=2π/|\vec{PC₁}|, Λ_{PC2}=2π/|\vec{PC₂}|.

The angles θ₁ and θ₂ are defined from the angle of grating vectors \vec{PC₁} and \vec{PC₂}.

As may be appreciated, a unit cell 300 is formed by the intersection of two sets of parallel lines, forming a parallelogram shape.

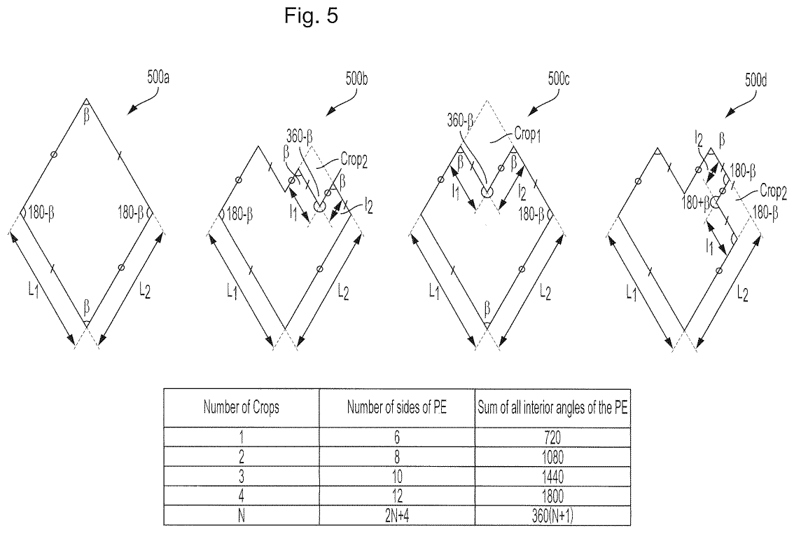

FIG. 4 illustrates an OCG 110 design for spatially tuning the TIR light to accommodate for deviations in the waveguide and relief toward the user's eye, and FIG. 5 illustrates example photonic structures 500 for use in a unit cell 300. As shown in FIG. 4, the OCG 110 is divided into multiple regions 302, which may be referred to as photonic crystal cells 302. FIG. 4 illustrates an example where the regions 302 are rectangularly shaped and in a grid pattern on the OCG 110. However, the OCG 110 may be divided differently so that regions 302 have a different size, a different shape, and/ or are arranged in a different pattern. In some cases, the size, shape, and pattern of the regions 302 are selected to optimize image quality (e.g., brightness and uniformity) for the user. Notably, the regions 302 are virtual divisions used for the sake of mapping groups of unit cells 300 and do not necessarily exist as physical dividing lines on the OCG 110.

As further shown in FIG. 4, each region 302 comprises a plurality of unit cells 300.

As shown in FIG. 5, each unit cell 300 comprises one or more photonic structures 500. FIG. 5 illustrates four example photonic structures 500a to 500d. All unit cells 300 in a particular region 302 may have a same shaped, sized, and oriented photonic structure 500 with the shape, size, and orientation of the photonic structures 500 in a particular region 302 being selected to match a desired diffraction efficiency for that particular region 302. Because different diffraction efficiencies are used in different regions 302, the shapes, sizes, and/or orientation of photonic structures 500 may vary between regions 302.

Stated another way, a plurality of unit cells 300 are arranged in groups on a base substrate of the OCG 110, such as part of the waveguide 104. The OCG 110 is divided into the regions 302. Each region 302 comprises a group of unit cells 300 that contain substantially identical photonic structures in shape, size, and orientation. However, the size, shape, and/or orientation of photonic structures may vary between groups of unit cells. For example, unit cells of a first group (in one of the regions 302) each include a first photonic structure in a first orientation and having a first size and a first shape. Meanwhile, unit cells of a second group (in a different region 302) each include a second photonic structure in a second orientation and having a second size and a second shape. According to embodiments, at least one of the first orientation, the first size, and the first shape of the first photonic structure is different than the second orientation, the second size, and the second shape of the second photonic structure.

Notably, the present disclosure refers to size, shape, and orientation of structures from a plan view perspective of the structure, such as the views shown in FIGS. 5-8. A photonic structure's size may be determined by the two-dimensional surface area (or footprint) of the photonic structure when viewed from the plan view without accounting for any variations in 3D profile. Size of a photonic structure may be measured by the amount of area (e.g., in percentage) the photonic structure occupies within a unit cell. Size of a unit cell may correspond to the two-dimensional surface area of the unit cell.

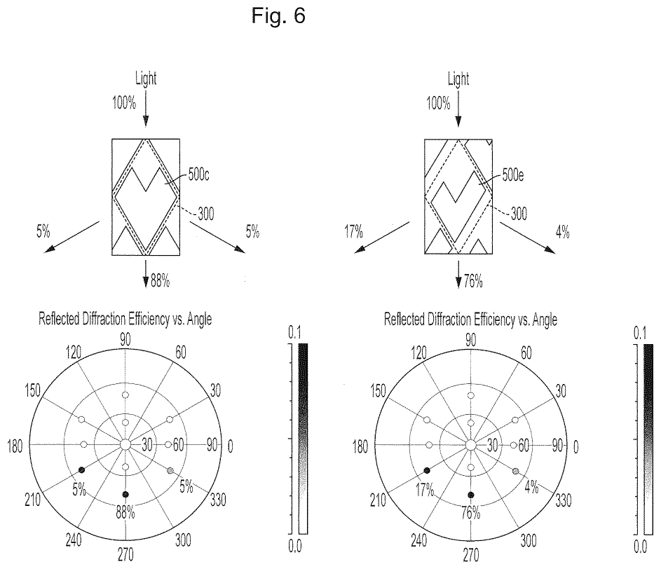

A photonic structure's shape may correspond to the two-dimensional shape when viewed from the plan view without accounting for any variations in 3D profile. Two photonic structures may be considered to have a same shape when each photonic structure has the same proportions of dimension (i.e., the only difference between the two structures is scale). Thus, two parallelograms having different proportions but same sizes (each occupies a same amount of area within a unit cell) are considered to have different shapes. In addition, two photonic structures of different sizes may be considered to have the same shape if the scale of the smaller sized shape can be enlarged to result in a structure that matches the dimensions of the larger sized shape. For example, photonic structures 500c and 500e in FIG. 6 are considered to have different shapes and sizes (orientation not a factor) while photonic structures 800a and 800b are considered to have a same shape and a same size with different orientations.

A shape of a unit cell may correspond to the two-dimensional shape of the unit cell viewed from the plan view. Meanwhile, a photonic structure's orientation corresponds to the position of the photonic structure in 2D space relative to a reference when viewed from the plan view (the reference may correspond to a central axis of a unit cell). Orientation of a unit cell may correspond to the position of the unit cell in 2D space relative to a reference when viewed from the plan view (the reference may correspond to the propagation direction of light in FIG. 1, for example). In view of the above, it should be appreciated that two photonic structures from unit cells of different regions 302 may differ in one or more of shape, size, and orientation.

As shown in FIG. 4, the unit cells 300 in a region 302 are periodically repeated along two non-parallel axes in a parallelogram geometry with Λ_{PC1} and Λ_{PC2} dimensions. Λ_{PC1} and Λ_{PC2} reflect the periodicity of the unit cell 300, and the values for Λ_{PC1} and Λ_{PC2} may depend on the operating wavelength, material properties, and/or design choice. In some examples, Λ_{PC1} and Λ_{PC2} are between 200 nm and 620 nm. In other examples, Λ_{PC1} and Λ_{PC2} are between 300 nm and 550 nm. In some cases, the values for Λ_{PC1} and Λ_{PC2} are equal to one another across the unit cells 300 in a region 302 or in all regions 302. In other cases, the values for Λ_{PC1} and Λ_{PC2} are different. With reference to FIG. 3, the shape of a unit cell 300 is defined by an angle α_{PC} &#8211; which is the smallest angle of the parallelogram defining the unit cell 300. The angle α_{PC} may be selected depending on the geometry of the desired Field of View (FOV) as represented in the k-space. The angle α_{PC} is between 30° and 90°, such as between 40° and 80°, or between 50° and 65°. As may be appreciated, the unit cells 300 in a particular region 302 have a same size, a same shape, and a same orientation. In some examples, the unit cells 300 have a same size, a same shape, and a same orientation for all regions 302. As shown in FIG. 4, a central axis A (e.g., a longitudinal axis) of a unit cell 300 may be aligned with the propagation direction of light in the waveguide 104 from an ICG 108. In some cases, however, the central axis A of a unit cell may be rotated at an angle (e.g., less than 90° rotated) compared to the propagation direction of light.

FIG. 5 illustrates four example photonic structures (also called photonic elements (PE)) 500a to 500d. Each unit cell 300 comprises a single photonic structure 500 or multiple, stacked, photonic structures 500. Stated another way, a unit cell 300 includes m number of photonic structures which can be stacked as n number of layers in a direction perpendicular to the light propagation direction (also called the TIR direction or propagation direction of light in FIG. 1). A photonic structure 500 may be made of one or more materials having a refractive index between 1.2 and 2.6. A photonic structure 500 may exhibit low absorption in the visible wavelength range and may comprise a polymer, a hybrid (organic/inorganic) resist, or an inorganic film such as glass.

The present disclosure proposes photonic structures 500 that enable control over the spatial diffraction efficiency in 3-dimensions which results in improved image brightness and uniformity. The photonic structures 500a to 500d adhere to the following set of rules or conditions: 1) a photonic structure 500 has a shape that is derived from a parallelogram reference shape and the photonic structure 500 is parallelepiped with a substantially constant thickness (height) between 1.0 nm and 500.0 nm or between 5.0 nm and 320.0 nm; 2) the parallelogram reference shape has lengths L1 and L2; 3) the area of the parallelogram reference shape is smaller than the area of a unit cell 300 so that the photonic structure 500 fits within a unit cell 300; 4) the photonic structure 500 may be cropped compared to the parallelogram reference shape; 5) the crop is applied to main corners or sub-corners of the photonic structure 500 (where a main corner is defined as one of the corners of the photonic structure 500a and where a sub-corner is defined as a corner created by cropping a main corner as in photonic structure 500b); 6) the crop can be applied one or multiple times so long as the table in FIG. 5 is adhered to; 7) the cropped side is parallel to a side of the parallelogram reference shape; and 8) the lengths of the cropped sides 11 and 12 are in the range 0<l1<L1 and 0<l2<L2.

As may be appreciated, photonic structure 500a is uncropped and shows the parallelogram reference shape from which photonic structures 500b to 500d are derived.

Accordingly, photonic structure 500a may also be referred to as the reference shape 500a. Photonic structure 500c illustrates a single crop (Crop 1) of a main corner of the reference shape 500a. Photonic structure 500b illustrates the crop from 500c and an additional crop (Crop 2) to one of the sub-corners of the shape in 500c created by the first crop (Crop 1). Meanwhile, photonic structure 500d illustrates the crop from 500c and an additional crop (Crop 2) to a main corner of the reference shape 500a.

The reference shape 500a has two equal angles β. The angle β may be between 30° and 90°, such as between 40° and 80°, or between 50° and 65°. In some examples, the angle β within a photonic structure 500 and the angle α_{PC} of a unit cell 300 having the photonic structure 500 are substantially equal, but may also be different. As may be appreciated from photonic structures 500b and 500c, a crop to the reference shape 500a may form an additional corner with angle β within the remaining part of the photonic structure.

The photonic structures shown in the figures are implemented with pillar configurations where the photonic structures protrude from a base substrate. However, the photonic structures may additionally or alternatively be implemented with hole configurations where the photonic structures are indentations into a base substrate (e.g., comprised of resin).

FIG. 6 illustrates diffraction characteristics for two different photonic structures according to at least one example embodiment. In more detail, FIG. 6 illustrates the diffraction characteristics, which includes graphs for reflected diffraction efficiency vs. angle, for photonic structure 500c from FIG. 5 and for another photonic structure 500e that includes more crops than 500c. FIG. 6 further illustrates the outline of a unit cell 300, which has the same parallelogram shape as the reference shape 500a. The shaded and unshaded regions next to each unit cell 300 correspond to the photonic structures of adjacent unit cells 300 (recall that the shape of a photonic structure 500 is repeated for all unit cells 300 in a particular region 302). The unshaded regions may correspond to a layer under the photonic structures 500, such as a base substrate which may include or correspond to part of the waveguide 104.

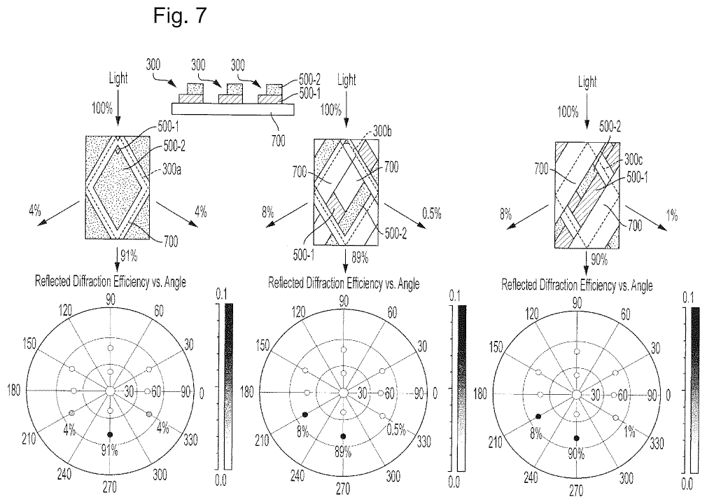

FIG. 7 illustrates diffraction characteristics, which includes graphs for reflected diffraction efficiency vs. angle, for three different unit cells 300a to 300c that each have multiple layers of photonic structures stacked on a base substrate. In particular, FIG. 7 illustrates plan views of unit cells 300a to 300c with multilayer designs having a first photonic structure 500-1 stacked on a base substrate 700, such as a waveguide 104, and a second photonic structure 500-2 stacked on the first photonic structure 500-1. As alluded to by the cross-sectional view in FIG. 7, the first photonic structure 500-1 is assumed to exist under and completely overlap with the second photonic structure 500-2. Stated another way, the regions shown in FIG. 7 as belonging to the second photonic structure 500-2 have identically shaped and sized regions of the first photonic structure 500-1 underneath the second photonic structure 500-2. In other examples, however, the second photonic structure 500-2 may include overhang regions that do not have a corresponding photonic structure 500-1 underneath. In this case, the space between the second photonic structure 500-2 and the base substrate may correspond to an air gap. Like FIG. 6, the shaded and unshaded regions next to each unit cell 300a to 300c in FIG. 7 correspond to adjacent unit cells 300.

Unit cell 300a shows a multilayer structure where the first photonic structure 500-1 has the reference shape 500a and where the second photonic structure 500-2 includes a small crop at the tip of the reference shape 500a closest to the light input region of the unit cell 300 a (where the 100% arrow is). Unit cell 300 b shows a multilayer structure where the first photonic structure 500-1 has been cropped compared to the reference shape 500a to form a V-shape and the second photonic structure 500-2 has been cropped compared to the reference shape 500a to form a smaller parallelogram on stop of a portion of the V-shape. Meanwhile, unit cell 300c shows a multilayer structure where the first photonic structure 500-1 has been cropped compared to the reference shape 500a to form a smaller parallelogram and where the second photonic structure has been cropped compared to the reference shape 500a to form an even smaller parallelogram on the first photonic structure 500-1.

Here, it should be appreciated, that each layer of photonic structure in a multilayer design may have a different refractive index than one or more other layer of photonic structure in the multilayer design. In other examples, one or more layers of photonic structure in the multilayer design have a same refractive index. It should be further appreciated from FIG. 7 that the base substrate 700 is exposed in regions between unit cells (see unit cell 300a) and in regions that do not have photonic structures 500-1 and/or 500-2 (see unit cells 300b and 300c). In some cases, one or more layers not considered to be a photonic structure 500 are positioned between the base substrate 700 and the first photonic structure 500-1. In this case, the absence of a photonic structure 500 exposes one of these layers. In addition, a multilayer photonic structure for a unit cell 300 may include more than the two photonic structures 500a and 500b discussed above and shown in FIG. 7. Each layer may be formed separately from the other layers.

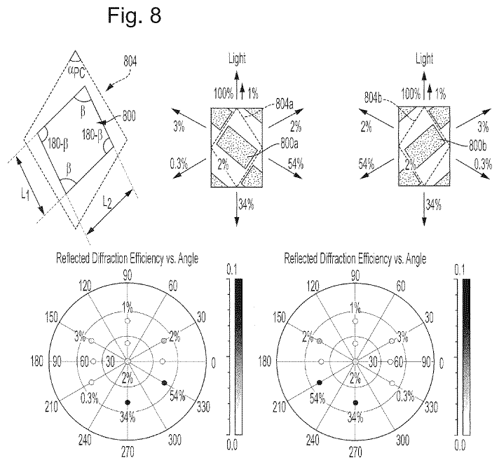

FIG. 8 illustrates another example design for a photonic structure within a unit cell. In more detail, FIG. 8 illustrates a photonic structure 800 having a parallelogram shape within a unit cell 804 having the same or similar shape, size, and orientation as the unit cell 300 in FIG. 3. As with the photonic structures 500, the photonic structure 800 may provide control over the spatial diffraction efficiency in 3-dimensions which results in improved image brightness and uniformity. An OCG 110 may include a plurality of unit cells 804 distributed across regions 302 in the same or similar manner as the unit cell 300. Each set of unit cells 804 in a region 302 may have the same shaped, sized, and oriented photonic structure 800. A photonic structure 800 within a unit cell 804 should adhere to the following rules or conditions: 1) the photonic structure 800 is parallelepiped, has a parallelogram shape (e.g., the same or similar as reference shape as 500 a), and has a substantially constant thickness (height) between 1.0 nm and 500.0 nm, or between 5.0 nm and 320.0 nm; 2) the parallelogram shape is defined by lengths L₁ and L₂ and a two-dimensional area of the photonic structure 800 is smaller than the area of the unit cell 804; and 3) the angle ß of the photonic structure 800 is different than the angle α_{PC} of the unit cell 804. In some cases and as shown in FIG. 8, the photonic structure 800 is rotated compared to the unit cell 804 by a selected angle. Compared to the photonic structures 500, a photonic structure 800 is not necessarily cropped from a reference shape.

FIG. 8 illustrates two example photonic structures 800a and 800b within respective unit cells 804a and 804b, and their associated diffraction characteristics which includes a reflection diffraction efficiency vs. angle graph. Photonic structure 800a comprises a parallelogram shape having an angle β different than the angle α_{PC} and which is rotated compared to the unit cell 804a. Photonic structure 800b comprises the same parallelogram shape as 800a except that photonic structure 800 b is rotated 90° compared to 800a.

Although not explicitly shown, it should be appreciated that the unshaded regions in FIG. 8 may correspond to an exposed base substrate (e.g., base substrate 700) or other layer of a waveguide 104 and that shaded regions neighboring the unit cell 804 are photonic structures 800 of adjacent unit cells 804.

Although not explicitly shown, it should be appreciated that a unit cell 804 may comprise a multilayer structure having multiple photonic structures 800 stacked on one another in the same or similar fashion as described above with reference to FIG. 7. Additionally or alternatively, a multilayer structure within a unit cell may include the uncropped but rotated parallelogram shape of a photonic structure 800 stacked on or under a cropped and unrotated photonic structure 500.

FIG. 9 illustrates a schematic view of a head mounted display (HMD) 1300 according to at least one example embodiment.

The HMD 1300 may include a wearable frame 10 that supports elements of the HMD 1300, hinges 11 at ends 10A of the frame 10 that enable movement of temple portions 12 that hold the HMD 1300 to the head of an observer 40, ear pieces 13 that removably mount to ears of the observer 40, nose pads 14, wiring 15 that connects to an external processing circuit (not shown) where image processing operations are carried out, for example, on the basis of output from camera 18. The HMD 1300 may further include headphones 16, headphone wirings 17, an image sensor or camera 18 mounted to a face 10B of the frame 10 in a central portion 10C of the frame 10, a member 20 to which image generating devices 111A and 111B are mounted through, for example, a casing 113, and waveguides 104 that rest in front of pupils 41 of the observer 40 when wearing the HMD 1300. As may be appreciated, the image generating devices 111A and 111B may each include an optical system for providing input light to a respective waveguide 104. The optical system for each image generating device 111A and 111B may include one or more light sources, one or more lenses, one or more prisms or mirrors, one or more light modulators, and/or other suitable elements for generating input light for a waveguide 104. Each waveguide 104 take the form of one or more of the waveguides 104 discussed above with reference to FIGS. 1 to 8 and receive the input light shown in FIG. 1 from one of the image generating devices 111A and 111B.

Here, it should be appreciated that the above described details relate to one non-limiting example of an HMD 1300, and the HMD 1300 may include more or fewer elements than those illustrated and described above.

Now with reference to FIGS. 1-9, it should be appreciated that example embodiments are directed to an OCG 110 for a waveguide-based display 102. The OCG 110 may include a base substrate, such as base substrate 700, which may be part of waveguide 104 (i.e., waveguide material) and/or another suitable layer on a surface of waveguide 104. The OCG 110 may include a plurality of unit cells 300 arranged in groups on the base substrate 700. Each group of unit cells 300 may correspond to one of the regions 302. In some examples, unit cells 300 of a first group each include a first photonic structure in a first orientation and having a first size and a first shape, and unit cells 300 of a second group each include a second photonic structure in a second orientation and having a second size and a second shape. As described herein, one or more of the first orientation, the first size, and the first shape of the first photonic structure are different than the second orientation, the second size, and the second shape of the second photonic structure. In particular, the size, shape, and orientation of the photonic structures in each region are selected to provide desired diffraction characteristics for a particular region 302 of the OCG 110.

In some examples, the first shape of the first photonic structure is a parallelogram shape, each unit cell 300 in the first group has a parallelogram shape, and the first orientation is different than the second orientation so that the parallelogram shape of the first photonic structure is rotated with respect to the parallelogram shape of each unit cell 300 (see FIG. 8). In addition, angles of the parallelogram shape of the first photonic structure may be different than angles of the parallelogram shape of each unit cell 300 in the first group.

In some examples and as shown in FIGS. 5 and 6, the first shape of the first photonic structure is based on a parallelogram reference shape and has a cropped area comprising one or more crops where part of the first photonic structure is missing compared to the parallelogram reference shape. As shown in the figures, each of the one or more crops defines two intersecting sides of the first photonic structure, and each unit cell in the first group also has a parallelogram shape. The two intersecting sides may have a same length that is less than a length of at least one other side of the first photonic structure. As shown in FIGS. 3 and 5, two angles of the parallelogram shape of each unit cell 300 are the same as two angles of the first photonic structure.

In some examples, the cropped area of the first photonic structure is at a first end of the parallelogram shape of each unit cell 300, and an uncropped area of the first photonic structure is at a second end of the parallelogram shape of each unit cell opposite the first end (see FIG. 5, for example). For each unit cell 300 in the first group, the first end corresponds to a point where first and second sides of a unit cell 300 meet, and the second end corresponds to a point where third and fourth sides of the unit cell meet. In some cases, a direction that points from the first end to the second end corresponds to a propagation direction of light in the waveguide-based display 102. In at least one example, the cropped area exposes a layer under the first photonic structure (the layer may correspond to the base substrate or a layer between the base substrate and the first photonic structure).

In some cases, each of the plurality of unit cells has a same size and a same shape. In addition, a thickness of the first photonic structure may be the same and constant in each unit cell 300 of the first group, and n a thickness of the second photonic may be the same and constant in each unit cell 300 of the second group.

As shown in FIG. 7, a third photonic structure may be stacked on the first photonic structure (e.g., 500-2 stacked on 500-1). The third photonic structure and the first photonic structure may have a different number of sides in a plan view. As may be appreciated from FIGS. 5-7, the first photonic structure has at least six sides in a plan view and at least three identical angles between 30° and 90°. Any details described above with reference to the first photonic structure may also apply to the second photonic structure and any other photonic structures of the OCG 110. In addition, it should be appreciated that a system may comprise a light source (11A/111B) and a waveguide 104 comprising the above described OCG 110.

Still with reference to FIGS. 1-9, example embodiments are directed to a waveguide including a base substrate (e.g., 700), an input coupling grating (ICG) 108 that receives light from a light source (e.g., 111A/111B), an output coupling grating (OCG) 110 that outputs light. The OCG 110 may comprise a plurality of unit cells 300 arranged in groups on the base substrate at regular intervals (e.g., at a regular pitch). Unit cells 300 in at least one group of unit cells each include a first photonic structure having an even number of sides greater than six when viewed from a plan view, and each side of the first photonic structure is parallel to at least two other sides of the first photonic structure. Each unit cell 300 in the at least one group of unit cells comprises a second photonic structure stacked on the first photonic structure, and the second photonic structure has a different shape than the first photonic structure. Each of the plurality of unit cells 300 may have a parallelogram shape.

The embodiments described with reference to FIGS. 1-9 may be combined with one another in any suitable manner.

While this technology has been described in conjunction with a number of embodiments, it is evident that many alternatives, modifications and variations would be or are apparent to those of ordinary skill in the applicable arts. Accordingly, it is intended to embrace all such alternatives, modifications, equivalents, and variations that are within the spirit and scope of this disclosure.

It should be appreciated that inventive concepts cover any embodiment in combination with any one or more other embodiment, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Any processing devices, control units, processing units, etc. discussed above may correspond to one or many computer processing devices, such as a Field Programmable Gate Array (FPGA), an Application-Specific Integrated Circuit (ASIC), any other type of Integrated Circuit (IC) chip, a collection of IC chips, a microcontroller, a collection of microcontrollers, a microprocessor, Central Processing Unit (CPU), a digital signal processor (DSP) or plurality of microprocessors that are configured to execute the instructions sets stored in memory.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as an embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

Various aspects of the present disclosure are described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Example embodiments may be configured according to the following:
(1)

An output coupling grating (OCG) for a waveguide-based display, comprising:
a base substrate; and
a plurality of unit cells arranged in groups on the base substrate, wherein unit cells of a first group each include a first photonic structure in a first orientation and having a first size and a first shape, wherein unit cells of a second group each include a second photonic structure in a second orientation and having a second size and a second shape, and wherein one or more of the first orientation, the first size, and the first shape of the first photonic structure are different than the second orientation, the second size, and the second shape of the second photonic structure.
(2)

The OCG of (1), wherein the first shape of the first photonic structure is a parallelogram shape, wherein each unit cell in the first group has a parallelogram shape, and wherein the first orientation is different than the second orientation so that the parallelogram shape of the first photonic structure is rotated with respect to the parallelogram shape of each unit cell.
(3)

The OCG of one or more of (1) to (2), wherein angles of the parallelogram shape of the first photonic structure are different than angles of the parallelogram shape of each unit cell in the first group.
(4)

The OCG of one or more of (1) to (3), wherein the first shape of the first photonic structure is based on a parallelogram reference shape and has a cropped area comprising one or more crops where part of the first photonic structure is missing compared to the parallelogram reference shape.
(5)

The OCG of one or more of (1) to (4), wherein each of the one or more crops defines two intersecting sides of the first photonic structure, and wherein each unit cell in the first group also has a parallelogram shape.
(6)

The OCG of one or more of (1) to (5), wherein the two intersecting sides have a same length that is less than a length of at least one other side of the first photonic structure.
(7)

The OCG of one or more of (1) to (6), wherein two angles of the parallelogram shape of each unit cell are the same as two angles of the first photonic structure.
(8)

The OCG of one or more of (1) to (7), wherein the cropped area of the first photonic structure is at a first end of the parallelogram shape of each unit cell, and wherein an uncropped area of the first photonic structure is at a second end of the parallelogram shape of each unit cell opposite the first end.
(9)

The OCG of one or more of (1) to (8), wherein, for each unit cell in the first group, the first end corresponds to a point where first and second sides of a unit cell meet, wherein the second end shape corresponds to a point where third and fourth sides of the unit cell meet, and wherein a direction that points from the first end to the second end corresponds to a propagation direction of light.
(10)

The OCG of one or more of (1) to (9), wherein the cropped area exposes a layer under the first photonic structure.
(11)

The OCG of one or more of (1) to (10), wherein each of the plurality of unit cells has a same size and a same shape.
(12)

The OCG of one or more of (1) to (11), wherein a thickness of the first photonic structure is the same and constant in each unit cell of the first group, and wherein a thickness of the second photonic is the same and constant in each unit cell of the second group.
(13)

The OCG of one or more of (1) to (12), wherein the base substrate comprises waveguide material.
(14)

The OCG of one or more of (1) to (13), further comprising: a third photonic structure stacked on the first photonic structure.
(15)

The OCG of one or more of (1) to (14), wherein the third photonic structure and the first photonic structure have a different number of sides in a plan view.
(16)

The OCG of one or more of (1) to (15), wherein the first photonic structure has at least six sides in a plan view and at least three identical angles between 30° and 90°.
(17)

A waveguide, comprising:
a base substrate;
an input coupling grating (ICG) that receives light from a light source; and
an output coupling grating (OCG) that outputs light, the OCG comprising:
a plurality of unit cells arranged in groups on the base substrate at regular intervals, wherein unit cells in at least one group of unit cells each include a first photonic structure having an even number of sides greater than six when viewed from a plan view, wherein each side of the first photonic structure is parallel to at least two other sides of the first photonic structure.

(18)
The waveguide of (17), wherein each unit cell in the at least one group of unit cells comprises a second photonic structure stacked on the first photonic structure, and wherein the second photonic structure has a different shape than the first photonic structure.
(19)

The waveguide of one or more of (17) to (18), wherein each of the plurality of unit cells has a parallelogram shape.
(20)

A system, comprising:
a light source; and
a waveguide comprising:
an input coupling grating (ICG) that receives light from the light source; and
an output coupling grating (OCG) that outputs light, the OCG comprising:
a base substrate; and
a plurality of unit cells arranged in groups on the base substrate, wherein unit cells of a first group each include a first photonic structure in a first orientation and having a first size and a first shape, wherein unit cells of a second group each include a second photonic structure in a second orientation and having a second size and a second shape, and wherein one or more of the first orientation, the first size, and the first shape of the first photonic structure are different than the second orientation, the second size, and the second shape of the second photonic structure.

What is claimed is:

1. An output coupling grating (OCG) for a waveguide-based display, comprising:
a base substrate; and
a plurality of unit cells arranged in groups on the base substrate, wherein unit cells of a first group each include a first photonic structure in a first orientation and having a first size and a first shape, wherein unit cells of a second group each include a second photonic structure in a second orientation and having a second size and a second shape, and wherein one or more of the first orientation, the first size, and the first shape of the first photonic structure are different than the second orientation, the second size, and the second shape of the second photonic structure.

2. The OCG of claim 1, wherein the first shape of the first photonic structure is a parallelogram shape, wherein each unit cell in the first group has a parallelogram shape, and wherein the first orientation is different than the second orientation so that the parallelogram shape of the first photonic structure is rotated with respect to the parallelogram shape of each unit cell.

3. The OCG of claim 2, wherein angles of the parallelogram shape of the first photonic structure are different than angles of the parallelogram shape of each unit cell in the first group.

4. The OCG of claim 1, wherein the first shape of the first photonic structure is based on a parallelogram reference shape and has a cropped area comprising one or more crops where part of the first photonic structure is missing compared to the parallelogram reference shape.

5. The OCG of claim 4, wherein each of the one or more crops defines two intersecting sides of the first photonic structure, and wherein each unit cell in the first group also has a parallelogram shape.

6. The OCG of claim 5, wherein the two intersecting sides have a same length that is less than a length of at least one other side of the first photonic structure.

7. The OCG of claim 5, wherein two angles of the parallelogram shape of each unit cell are the same as two angles of the first photonic structure.

8. The OCG of claim 5, wherein the cropped area of the first photonic structure is at a first end of the parallelogram shape of each unit cell, and wherein an uncropped area of the first photonic structure is at a second end of the parallelogram shape of each unit cell opposite the first end.

9. The OCG of claim 7, wherein, for each unit cell in the first group, the first end corresponds to a point where first and second sides of a unit cell meet, wherein the second end corresponds to a point where third and fourth sides of the unit cell meet, and wherein a direction that points from the first end to the second end corresponds to a propagation direction of light.

10. The OCG of claim 5, wherein the cropped area exposes a layer under the first photonic structure.

11. The OCG of claim 1, wherein each of the plurality of unit cells has a same size and a same shape.

12. The OCG of claim 1, wherein a thickness of the first photonic structure is the same and constant in each unit cell of the first group, and wherein a thickness of the second photonic is the same and constant in each unit cell of the second group.

13. The OCG of claim 1, wherein the base substrate comprises waveguide material.

14. The OCG of claim 1, further comprising:
a third photonic structure stacked on the first photonic structure.

15. The OCG of claim 14, wherein the third photonic structure and the first photonic structure have a different number of sides in a plan view.

16. The OCG of claim 1, wherein the first photonic structure has at least six sides in a plan view and at least three identical angles between 30° and 90°.

17. A waveguide, comprising:
a base substrate;
an input coupling grating (ICG) that receives light from a light source; and
an output coupling grating (OCG) that outputs light, the OCG comprising:
a plurality of unit cells arranged in groups on the base substrate at regular intervals, wherein unit cells in at least one group of unit cells each include a first photonic structure having an even number of sides greater than six when viewed from a plan view, wherein each side of the first photonic structure is parallel to at least two other sides of the first photonic structure.

18. The waveguide of claim 17, wherein each unit cell in the at least one group of unit cells comprises a second photonic structure stacked on the first photonic structure, and wherein the second photonic structure has a different shape than the first photonic structure.

19. The waveguide of claim 17, wherein each of the plurality of unit cells has a parallelogram shape.

20. A system, comprising:
a light source; and
a waveguide comprising:
an input coupling grating (ICG) that receives light from the light source; and
an output coupling grating (OCG) that outputs light, the OCG comprising:
a base substrate; and
a plurality of unit cells arranged in groups on the base substrate, wherein unit cells of a first group each include a first photonic structure in a first orientation and having a first size and a first shape, wherein unit cells of a second group each include a second photonic structure in a second orientation and having a second size and a second shape, and wherein one or more of the first orientation, the first size, and the first shape of the first photonic structure are different than the second orientation, the second size, and the second shape of the second photonic structure.
